(19) United States
(12) Patent Application Publication
(10) Pub. No.: US 2022/0131718 A1
(43) Pub. Date: Apr. 28, 2022

(54) SYSTEM AND METHOD FOR CONTROLLING DEVICES

(71) Applicant: DIZMO AG, Zurich (CH)

(72) Inventor: Matthias Aebi, Zurich (CH)

(21) Appl. No.: 17/509,244

(22) Filed: Oct. 25, 2021

Related U.S. Application Data
(60) Provisional application No. 63/105,342, filed on Oct. 25, 2020.

(51) Int. Cl. H04L 12/28; G10L 15/22

(52) U.S. Cl. CPC H04L 12/2807; H04L 12/282; H04L 2012/285; G10L 15/22; G10L 2015/223; H04L 12/2818

(57) ABSTRACT

Systems and methods are described for controlling and orchestrating devices. The systems and methods receive information in the form of requests indicating that attributes of the devices are to be changed and generate event expressions corresponding to the requests or data. The event expressions are interpreted to select target devices having attributes to be changed as a result of the event, with device control commands being generated to change the attributes of the devices. The systems and methods may use near natural language syntax in the event expressions. The systems and methods may also use digital twins of the devices, with the digital twins having virtual attributes corresponding to the attributes of the devices.

### BACKGROUND

### Field of the Invention

The invention relates to a system for controlling devices. In particular embodiments, the invention relates to a system and method for controlling the attributes of smart home devices.

### Related Art

The Internet of things (IoT) describes a network of physical objects that are embedded with sensors, software, and other technologies for the purpose of connecting and exchanging data with other devices and systems. In the consumer market, IoT technology is most synonymous with products pertaining to “smart homes,” including devices and appliances that are used in home environments. As smart home technology becomes increasingly sophisticated, there is a corresponding increase in consumer interest in the technology.

There are several technical problems with current IoT networks, particularly when applied to smart home automation. From a user's perspective, adding devices to a smart home network and setting up the devices is difficult, so much so that often a skilled technician must be consulted. In fact, it has been estimated that up to 70% of the overall cost in setting up a sophisticated smart home system is a result of fees associated with having skilled technicians configure the system. Another problem with smart home systems lies in the limitations in the user interfaces for interacting with the devices. Most user interfaces are limited to function in the manner of a remote control in that the users must individually configure the devices and instruct each of the devices separately according to their desires. The user interface must also be operated in a specific, non-intuitive manner. Yet another problem lies in the difficultly of making the devices work together in a coordinated manner. The many different manufacturers of devices and the ensuing differences in how the devices are configured, networked, etc., contribute to the difficulties in device coordination. To the extent that smart home device coordination is possible, it is limited to setting up specific “scenes.” For example, the user may specify a scene that sets the operating states of the devices at a particular time of day and in a specific place in the home. But setting up a scene requires detailed programing by the user, and more sophisticated coordination of the devices is not possible with a scene-based approach.

There are also technical problems for developers and technicians implementing a smart home system. One problem is that having many different manufacturers of smart home devices leads to differences in how the devices are controlled, e.g., devices from different manufacturers have different control commands and behaviors. The differences can substantially increase the amount of program coding and configuration work for the system. Also, diagnosing problems arising in the systems is often difficult. For example, when debugging a system, the log files of the system are often hard to read and interpret, and sometimes spread across multiple systems and devices.

### SUMMARY OF THE INVENTION

According to one aspect of the invention a control system is provided that is connectable to a plurality of devices. The control system includes one or more computer processors, and one or more memories storing instructions to be executed by the one or more computer processors. The instructions stored in the one or more memories are executable by the one or more computer processors to cause the control system to function as a receiving module that is capable of receiving a request that entails changing attributes of devices; an expression generation module that is capable of generating, based on the request, an event expression corresponding to the changes in attributes of devices; an expression interpretation module that is capable of interpreting the event expression to select target devices having attributes to be changed, the event interpretation module being configured to use (i) a group table that indicates groups of devices sharing at least one characteristic, (ii) a location tree indicating a hierarchy of locations for the devices, and (iii) a virtual event matrix correlating attributes of the devices to events; an event interpretation module that is capable of generating device control commands for changing the attributes of the selected target devices; and a transmission module that is capable of transmitting the device control commands to the selected target devices.

According to another aspect of the invention, a control system is connectable to a plurality of devices. The control system includes one or more computer processors, and one or more memories storing instructions to be executed by the one or more computer processor. The instructions stored in the one or more memories are executable by the one or more computer processors to cause the control system to function as a receiving module that is capable of receiving a request that entails changing attributes of devices; an expression generation module that is capable of generating an event expression corresponding to the changes in attributes of devices based on the request, the event expression (i) having near natural language syntax and (ii) specifying an event and a description of a set of devices with attributes to be changed in accordance with the event; an expression interpretation module that is capable of interpreting the event expression to select target devices having attributes to be changed; an event interpretation module that is capable of generating device control commands for changing the attributes of the selected target devices; and a transmission module that is capable of transmitting the device control commands to the selected target devices.

According to yet another aspect of the invention, a method is provided for controlling a plurality of devices. The method includes receiving at a computer control system a request that necessitates changes in attributes of the devices; generating an event expression corresponding to the changes in attributes of the devices based on the request; interpreting the event expression to select target devices having attributes to be changed as a result of the event, the determination being made by using (i) a group table that indicates groups of devices sharing at least one characteristic, (ii) a location tree indicating a hierarchy of locations for the devices, and (iii) a virtual event matrix correlating attributes of the devices to events; generating device control commands for changing the attributes of the selected target devices; and transmitting the device control commands to the selected target devices using a wired or wireless protocol.

### BRIEF DESCRIPTION OF THE DRAWINGS

FIG. 1 illustrates an embodiment of the invention as applied in a smart home environment.

FIG. 2 illustrates exemplary functional modules that may be included in a memory device and used to produce the functionalities of a control system according to an embodiment of the invention.

FIG. 3 is an illustration of an example of a location tree that could be used in embodiments of the invention.

FIG. 4 is a conceptual drawing showing an execution chain according to embodiments of the invention.

### DETAILED DESCRIPTION OF THE INVENTION

The present invention relates to systems, methods, and computer program products for controlling devices. Particular embodiments of the invention specifically relate to controlling devices that are part of a smart home environment. However, as discussed further below, embodiments of the invention are not limited to smart home systems, and may be used with other types of devices and subsystems and in other locations.

Systems as described herein may include user interface(s) operatively connected to a controlling device that is also operatively connected to other device(s). The term “system” will be used to refer to a combination of user interface(s), the controlling device, and the other devices. The terms “control system” and “computer control system” be associated with the controlling device, but not the user interface(s) and other connected devices.

Devices in embodiments of the invention have one or more attributes. Attributes are information about aspects of the device, such as its current operating state, its environment, its inner workings, and the last things that happened to the device. Examples of attributes of devices include brightness, color, audio volume, current power usage, time till end of process (e.g., in a washing machine, an oven), target temperature, whether the device is open or closed. Of course, different types of devices will have different attributes. As will be described below, in embodiments of the invention events are interpreted by the control system to change virtual attributes of digital twins of the devices, and the control system sends commands to devices that cause the attributes of the devices to match the changed virtual attributes.

Control systems according to embodiments of the invention adjust the attributes of devices of the system in response to requests from users or devices of the system. When the control system receives a request, the control system functions to determine an event expression based on the request, interpret the event, and send control commands to change attributes of appropriate devices based on the interpreted event. Events in the control system are defined at a high-level, as users of the system would think about the devices of the system operating in a combined and/or orchestrated manner. For example, when the system is being used in a smart home environment, users will be thinking of things such as “it is too hot in this room,” “I want to watch television,” “when I wake up, I want the kitchen to be bright but not too bright.” Events in the control systems herein correspond to such thoughts would be “colder,” “on,” “open,” “watch television,” and “medium brightness.” Examples of other events are off, bright, brighter, dark, darker, louder, softer, quiet, warm, warmer, cold, colder, wakeup, sunrise, sundown, last one leaves, first one arrives, guests arrive, guests leave, sleeping now, close, intrusion alarm, fire alarm, gas alarm, carbon dioxide critical, rain coming, frost coming, storm coming, reduce power, standard power, increase power, vacation starts, vacation ends, doorbell, device failed, record scene, set scene, remove scene, notify user of message, and set (for setting the value of an attribute directly).

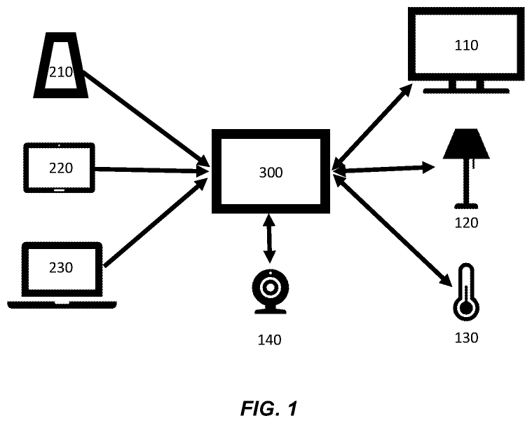

FIG. 1 illustrates a system according to an embodiment of the invention as applied in a smart home environment. The system includes devices 110, 120, 130, and 140; user interfaces 210, 220, 230, and a control system 300 that includes modules for implementing the control of attributes of the devices 110, 120, 130, and 140.

The interfaces 210, 220, and 230 are configured to accept requests from a user to thereby initiate control processes in the system. The user may enter the request using any one of the three user interfaces 210, 220, and 230. Alternatively, a combination of the interfaces could be used to initiate a request, and the system could have any number of user interfaces. In the example system shown in FIG. 1, the system includes a voice activation device 210, a tablet computer 220, and a laptop computer 230. However, as will be appreciated by those skilled in the art, the user interfaces could take a wide variety of other forms. Other examples of user interfaces that could be used in the system include a wall button or some other physical switch, a connected push button, wearable devices (such as a watch or eyeglasses), and a device that detects gestures of a user. Regarding such gestures, the user could, for example, perform gestures on a touch screen captured by a camera, or perform gestures that are captured by an accelerometer in a device worn by the user. Still further examples of user interfaces for the system are touch-sensitive surfaces that may be manipulated, such as display monitor or any other surface on which a projection image may be displayed, printed, drawn, or otherwise reproduced. Regarding the projection image, when the system is deployed in a smart home environment, the image might be projected on objects around the house, such as cabinets and tables. In image-based user interfaces, graphical elements may be used to facilitate interactions with the control system. Examples of such graphical elements can be found in U.S. Pat. No. 9,645,718, which is to the same assignee as the present application and is incorporated herein by reference in its entirety.

The interfaces 210, 220, and 230 are operatively connected to the control system 200. In embodiments of the invention, the control system is a computer system having a computer processor, a main memory, and an interconnecting bus. The computer processor may include a single microprocessor, or a plurality of microprocessors for configuring the control system as a multi-processor system. The main memory stores, among other things, instructions and/or data for execution by the processor. The main memory may include banks of dynamic random memory, as well as cache memory.

The computer control system may further include mass storage device(s), peripheral device(s), input control device(s), portable storage medium device(s), graphics subsystem(s), and/or one or more output display(s). For explanatory purposes, all components in the computer systems described herein are coupled via a bus. However, the computer system is not so limited. Devices of the computer system may be coupled via one or more data-transport devices known in the art. For example, the computer processor and/or the main memory may be coupled via a local microprocessor bus. The mass storage device(s), the peripheral device(s), the portable storage medium device(s), and/or the graphics subsystem(s) may be coupled via one or more input/output (I/O) buses. The mass storage device(s) may be nonvolatile storage device(s) for storing data and/or instructions for use by the computer processor. The mass storage device may be implemented, for example, with one or more magnetic disk drive, solid state disk drive, and/or optical disk drive(s). In a software-related embodiment, at least one mass storage device is configured for loading contents of the mass storage device into the main memory.

Each portable storage medium device operates in conjunction with a nonvolatile portable storage medium, for example, a compact disc with a read-only memory (CD-ROM) or a non-volatile storage chip (Flash), to input and output data and code to and from the computer system. In some embodiments, the software for storing an internal identifier in metadata may be stored on a portable storage medium, and may be inputted into the computer system via the portable storage medium device. The peripheral device(s) may include any type of computer support device, such as, for example, an input/output (I/O) interface configured to add additional functionality to the computer system. For example, the peripheral device may include a network interface card for interfacing the computer system with a network.

The input control device(s) provide among other things, a portion of the user interface for a user of the control system. The input control device may include a keypad, a cursor control device, a touch sensitive surface coupled with the output display or standalone, a camera, a microphone, infrared sensors, knobs, buttons, and the like. The keypad may be configured for inputting alphanumeric characters and/or other key information. The cursor control device may include, for example, a mouse, a trackball, a stylus, and/or cursor direction keys. In order to display textual and graphical information, the computer system may utilize the graphics subsystem(s) and the output display(s). The output display(s) may include a cathode ray tube (CRT) display, a liquid crystal display (LCD), a projector device, and the like. Each graphics subsystem receives textual and graphical information, and processes the information for output to at least one of the output display(s).

Each component of the computer system may represent a broad category of a computer component of a general and/or special purpose computer. Components of the computer system are not limited to the specific implementations described herein.

Portions of the example embodiments of the invention may be conveniently implemented by using a conventional general purpose computer, a specialized digital computer, and/or a microprocessor programmed according to the teachings of the present disclosure, as will be apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein, which can be used to control, or cause, a computer to perform any of the procedures of the example embodiments of the invention. The storage medium may include without limitation a floppy disk, a mini disk, an optical disc, a Blu-ray Disc™, a DVD, a CD-ROM, a micro drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the example embodiments of the invention. Such software may include, without limitation, device drivers, operating systems, and user applications. Additionally, such computer readable media further includes software for performing example aspects of the invention, as described herein.

Referring again to FIG. 1, the control system 200 may be operatively connected to the user interfaces 210, 220, and 230 and to the devices 100, 101, 102, and 103 via interfaces operating according to wireless or wired protocols. Examples of wireless protocols include Wi-Fi, ZigBee, 6LoWPAN, Bluetooth®, HomeKit Accessory Protocol (HAP), and Weave. Examples of wired protocols include Ethernet, HomePlug, and serial interface protocols. Those skilled in the art will recognize other types of wired and wireless protocols that may be used in conjunction with the user interfaces, control system, and devices in embodiments of the invention. Further, the user interfaces, control system, and devices may include additional operative connections than are shown in FIG. 1. For example, all of the devices may be connected to the Internet to allow for remote access, operation, manipulation, etc.

It should also be noted that a user interface and the control system could be combined into a single device, such as a personal computer. Further, as will become apparent in the description that follows, the devices 100, 101, 102, and 103 may be combined with the user interfaces 210, 220, and 230 and/or computer control system 200, particularly when the devices 100, 101, 102, and 103 are virtual devices (which will be described below).

The devices 100, 101, 102, and 103 can take numerous forms. In some embodiments, one or more of the devices perform functions and tasks in a smart home environment. Examples of such devices include lighting devices, audio and/or video devices, heating and/or cooling devices, cooking appliances, cleaning appliances (e.g., vacuum cleaner, iron), a safety appliance (e.g., smoke detector), a window shade operating device, an alarm clock, a doorbell, a door lock, an alarm system, a temperature-control device, a lawn sprinkler system, and many others. In some embodiments, one or more of the devices may detect aspects of a home environment to provide information to the control system. Examples of such devices include a temperature sensor, a light sensor, a motion detector, a power-usage meter, a device detecting whether objects such as windows and doors are open or closed, and an internet communication device or sensor. In this regard, it should be noted that detection/sensor devices provide data that may be used in the interpretation of events in the control system, which will be described below.

In embodiments of the invention, one or more of the devices 100, 101, 102, and 103 may be a virtual device. A virtual device exists in a computer device (e.g., personal computer, tablet computer, smart phone) and may emulate some or all aspects of a real device. For example, a virtual light control device could be provided in a computing device, with the virtual light control device controlling the brightness level of a light in the same manner that a switch on the wall of a house controls the brightness level of the light. Another example of a virtual device is a button provided on a computing device that can be used to adjust the temperature of a location. Yet another type of virtual device that may be provided in systems according to embodiments of the invention provides an interface to generate specific event expressions in the system. For example, virtual devices could be provided as options on computing devices to indicate that a location should be secured, that the residents of the location are going on vacation, and that a party is going to be held at the location. When such virtual devices are operated by the user, event expressions are generated for the control system to interpret and process, and thereby change attributes of devices in the system, as will be described below.

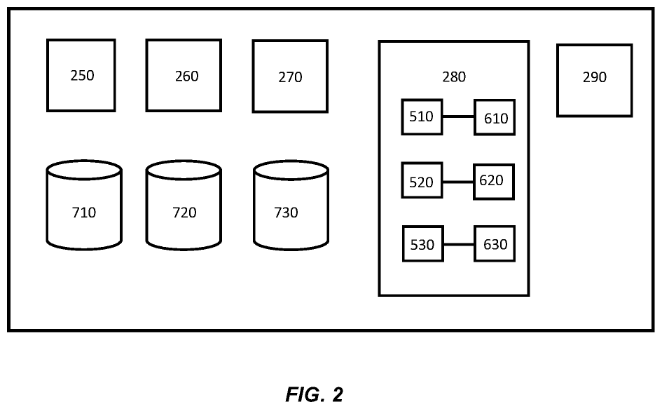

FIG. 2 illustrates functional modules and collections of data that may be included in control systems in embodiments of the invention. As discussed above, a general and/or special purpose computer may be used to deploy the control system. In such cases, the functional modules and collections of data shown in FIG. 2 are included in memory device(s) of such a computer. As shown in FIG. 2, the modules stored within the memory device include a receiving module 250, an expression generation module 260, an expression interpretation module 270, an event interpretation module 280, and a transmitting module 290. Each of the modules includes computer-executable code that imparts functionality to the control system when executed by the computer processor. Those skilled in the art will easily recognize the coding languages and techniques that may be used to create the modules and collections of data.

The receiving module 250 functions in association with a hardware interface for the control system to receive information from a user interface or device of the system. As discussed above, user interfaces, devices, and the control system may be operatively connected in the system using wireless and wired protocols, and, thus, the receiving module will function in accordance with such protocols. In processes according to embodiments of the invention, the receiving module 250 receives information in the form of a request from a user interface, or a request or data from a device of the system.

The expression generation module 260 creates event expressions for the requests received by the receiving module 250. The generated event expressions specify an event and a formal description of a set of devices to receive the event. The description of the set of devices may include names, types, and user defined groups of devices, as well as the location of devices intended to receive the event. The description may also include set operators or Boolean operators to combine multiple sets of devices. In some cases, the expression describing the set of devices will consist of only a device or devices, in other cases the expression will include one or more devices and a location, and in still other cases the expression will only include a location and no devices. Thus, “set of devices” as used herein does not require descriptions of actual devices, but rather could use a location to define a set.

In embodiments of the invention where a request is entered into the control system 200 through a voice activated user interface, the expression generation module 260 uses voice recognition artificial intelligence to perform a translation of the user's voiced requests to the event expressions used in the system. Those skilled in the art will appreciate the types of voice recognition programing techniques that will facilitate such translations. In some cases, the expression generation module 260 will generate event expressions by evaluating the request from the user or a request in the form of information received from a device using data recognition techniques. For example, the expression generation module 260 may parse data from a temperature sensor device of the system and thereby generate an expression for a temperature adjustment event. It some cases, the request coming from the device may already be in the form of an event expression, and, thus, the expression generation module 260 need not generate a new event expression. Also, in some embodiments, the control system may be provided with an additional module to send responses back to the user interface and/or devices when additional information is needed to clarify a received request.

One advantageous aspect of embodiments of the invention is that the expressions generated by the expression generation module 260 use a syntax that is near natural language syntax for easier event interpretation (which will be described below). “Near natural language syntax” as used herein means ordinary words and concepts as would be used by humans to describe the corresponding events, devices, and locations. Examples of near natural language for events in the expressions generated by the expression generation module 260 are “open” and “close” for an event indicating that an attribute of a device should be opened or closed, “brighter” for an event indicating that more light is needed in a location, “louder” for an event in which a device should is made to produce more noise, “colder” for an event in which a location should be made cooler, “doorbell” for an event generating actions as a result of a doorbell button having been pushed, and “vacation_starts” for an event in which attributes of devices at a location are changed to correspond to the user who lives at the location being on vacation. Examples of near natural language syntax for groups of devices in the expressions generated by the expression generation module 260 are “lights” to indicate a group of lights, “noise_generators” to indicate a group of noise generating devices, “video_devices” to indicate a group of video devices, and “security” to indicate a group of security devices. Examples of near natural language syntax for locations of devices in the expressions generated by the expression generation module 260 are “bedroom,” “north side,” “upstairs,” and “kitchen.”

Expressions of the event and set of devices that can be generated by the expression generation module 260 with near natural language syntax may take the form of event:set@location. Examples of expression are off:lights, meaning turn off all of the lights regardless of location; off:lights@bedroom, meaning turn off the lights in a bedroom location; and off:@bedroom, turn off all of the devices (not just lights) in the bedroom location. Note, the first of these expressions describes only the event and devices, the second includes devices and a location, and the third expressions include a location and no devices. Of course, the expressions are not limited to these particular forms in other embodiments of the invention.

Those skilled in the art will appreciate the advantages of using near natural language syntax for the expressions generated by the expression generation module. For example, developers will find it easier to create, modify, and relate events, groups, and locations with near natural language syntax. Further, using near natural language syntax facilitates the artificial intelligence transformation of language entered into the system through a voice activation user interface. The use of near natural language also makes monitoring and debugging a system easier, e.g., when reading and interpreting the log files produced by the system. What is more, using an expression generation module as described herein separates the human facing input side of the system from the actual control system. This is highly advantageous over prior art systems because it allows for user to articulate their requests in multiple ways, not just narrow, specific ways as required by prior art device control systems. And, at the same time, the near natural language syntax generated by the expression generation module produces clear and unambiguous expressions to be interpreted by the expression interpretation module.

The expression interpretation module 270 functions to interpret the expressions generated by the expression generation module 260. Through this interpretation, target devices having attributes that are related to the event are determined. In embodiments of the invention, the expression interpretation module 270 uses three collections of data to determine the target devices: a group table 710, a location tree 720, and a virtual event matrix 730, each of which will now be described.

Another beneficial aspect of embodiments of the invention is the use of the group table 710, which includes data for correlating groups of devices to be affected by events. Such groups are collections of devices that share some characteristic. Grouping according to characteristics allows for greater coordination in the devices of the system. That is, interpreting events to determine groups of applicable devices allows for more orchestrated responses by the system to requests than is possible with prior art systems. Examples of particular characteristics that could be used to define groups of devices include names, types, aspects, and functions of devices. Examples of groups of devices based on characteristics are heating devices; cooling devices; lighting devices such as artificial lights and window shade operating devices; video devices such as televisions, tablets, and personal computers; security devices; noise creating devices such as televisions, audio systems, household appliances, and children's toys; and high power usage devices such as a water heater, a clothes washer/dryer, and a dishwasher. As evident from this list, a device could belong to multiple groups, e.g., a television is a video device and a noise creating device. Those skilled in the art will easily recognize many other characteristics that could be used to create groups of devices as described herein. In example embodiments, the control system may be initially deployed with default groups of devices. Other groups may be created by the user by selecting any collection of devices and allocating them to a user defined and named group.

It should be noted that a grouping of devices in the group table is different from a set of target devices in an event expression. Groups of devices are defined by characteristics/attributes, such as name, type, etc., an example being a group of devices that create noise. The names and members of both predefined groups and user defined of groups are stored in the group table. On the other hand, sets of devices in event expressions are ad hoc collections of devices without a name, with the expression interpretation module functioning (using the below described virtual event matrix) to remove from a set any device that does not support the event to be forwarded to the event interpretation module. An example of a set is all of the devices in a room independent of their attributes, such as lights, window shades, and an alarm clock. For a lighting event, the alarm clock would be removed from this set by the expression interpretation module because the alarm clock does not have attributes related to the lighting event.

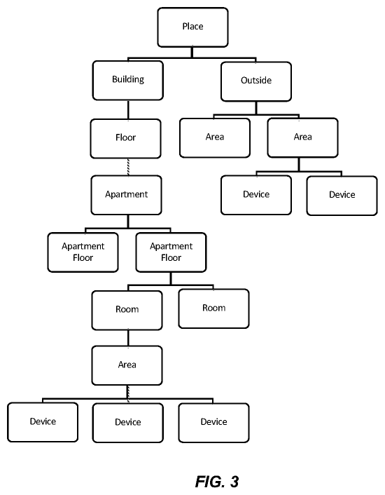

Another characteristic that can be used in the interpretation of the event expressions is location. To facilitate location characteristics of devices and groups of devices, systems according to embodiments of the invention use location data organized in the form of a hierarchy, such as the location tree 720 in the system shown in FIG. 2. Organizing location data in a hierarchy facilitates a wide variety of grouping possibilities. An example of such a hierarchy is shown in FIG. 3. In this example, a master bedroom is a sublocation of an apartment floor, of an apartment, on the floor, of a building, in a place. Devices located in the master bedroom can thereby be associated with groups of devices defined by the locations and sublocations in the hierarchy. For example, an overhead light in the master bedroom could be associated with a group of devices for the master bedroom, a group of devices for the floor of the apartment, or a group of devices for the apartment as a whole. Other examples of ways in which devices could be associated with locations are on the north, south, east, or west walls of a building, or on a floor, wall, or ceiling of a room. As further examples, the devices could be categorized by relative positions, such as above or below each other, or a device could be categorized by positions relative to other objects, such as near a fireplace in a house.

The virtual event matrix 730 correlates devices and events, in effect, taking into account the attributes of the devices, and how changes to those attributes may affect the environment in which they are placed and operated. In other words, the virtual event matrix 730 includes data to correlate events with the devices having attributes that can bring about effects required by the event. For example, if an event involves adjusting light, the virtual event matrix 730 will indicate that lights, window shade operating devices, etc., are target devices with attributes associated with the event. It should also be noted that the virtual event matrix 730 will implicitly indicate that other devices associated with the system are not to be associated with particular events. In the example of adjusting light, an audio device will not be associated with the event because only the devices that can affect lighting are associated with adjusting light events in the virtual event matrix 720.

The event interpretation module 280 functions to create the device control commands for changing the attributes of devices in accordance with the event as determined by the expression interpretation module 270. In embodiments of the invention, the event interpretation module 280 includes digital twins of devices 510, 520, and 530, and device controllers 610, 620, and 630 specific to the devices, with which the event interpretation module 280 generates the device control commands.

Generally speaking, a digital twin is a virtual model (in embodiments of the present invention, existing in a computer memory) of a device in context. Here, a digital twin includes data describing virtual attributes corresponding to the attributes of the actual device. The use of digital twins of the devices is advantageous because the basic logic for adjusting attributes of the devices can be made the same regardless of the specific manufacturer, configuration, etc., of the actual devices. For example, a digital twin for lighting devices is programmed such that its virtual attributes (on, off, brighter, dimmer, different color, etc.) can be changed when an event calling for a change in the attribute of lighting devices is interpreted by the event interpretation module. The digital twin will then indicate the change in attributes to the device controllers specific to the lighting devices in the system. As will be appreciated by those skilled in the art, digital twins provide an excellent architecture of a device system that allows for easy reuse and maintenance of code. Using digital twins to adjust the virtual attributes and then having the changed attributes applied by the specific device controllers greatly simplifies the programming necessary to implement attribute changes in a system with multiple devices. Moreover, adding new devices to an existing control system using digital twins is greatly simplified as the code for logic of the device is already in place with the digital twin; all that needs to be added to incorporate the new device is the device's specific controller code. Digital twins also provide for powerful and easy to use visualizations representing the devices. Such visualizations allow users to easily see an overview of the status of the devices connected to the system in various ways, such as maps, floor plans, in lists, graphs, gauges, etc. Visualized digital twins also make it simple for users to allocate any of the devices of a system to a group. One example of this would be allocating the digital twins to a color, which would then allow a user to refer to this group in requests given to the system, i.e., by referring to “blue devices.”

The digital twins 510, 520, and 530 of the event interpretation module 280 use the virtual event matrix 730 to take into account the current attributes of devices and attributes of locations. As indicated above, a device could have many attributes, one example being whether the device is on or off. Locations can have attributes as well, for example, the number of people present in the location, the time of day at the location, and whether the location is secured. The current attributes of a device and the current attributes of locations can be provided as part of the virtual event matrix 730, and these current attributes can be taken into account when adjusting the virtual attributes of the digital twins 510, 520, and 530.

In the example event interpretation module 280 shown in FIG. 2, three digital twins 510, 520, and 530 are shown, with the digital twins being associated with corresponding device controllers 610, 620, and 630. The output of the device controllers 610, 620, and 630 is device commands.

The transmission module 290 of the control system functions to send the commands to the devices 400 in the system though a hardware interface of the control system. The interface may be the same interface supporting wireless or wired protocols, as describe above in conjunction with the receiving module 250.

One significant aspect of embodiments of the invention is that default behaviors of devices may be set forth in the virtual event matrix 730 which, as described above, is used in the expression interpretation module 270 and in the event interpretation module 280. The default behaviors result from the mapping of requests onto events onto commands to modify one or more attributes of each device that has been defined to support a specific event. Having default behaviors greatly facilitates the initial setup of the system, as well as the incorporation of new devices into the system. Through conventional techniques, the control system can be made to recognize a new device when it is first operatively connected to the system. And once the new device is recognized, the attributes of the device will automatically be mapped to events in the virtual event matrix 730. For example, if a new light is connected to a smart home environment and is recognized by the control system, then the control system can automatically associate the new light with events that require changing attributes of brightness in a particular location. This default behavior is highly advantageous because no user involvement, nor work by a system configuration specialist, is required to make new devices function with an existing control system.

Another aspect of embodiments of the invention is the ability to introduce modifications to the default device attribute changes resulting from an event. Such modifications are referred to herein as “exceptions,” and may result in additional device attribute changes as a result of an event, less device attribute changes as a result of the event, modified device attribute changes as a result of the event, or a modified set of devices for which some attributes are changed. An exception may be introduced into the control system through a user interface, with the exceptions being added to the virtual event matrix. These exceptions may also be assigned to all or parts of the hierarchy set forth in the location tree, thereby indicating that the standard behavior in response to events in certain areas defined in the tree is to be modified. An example of an exception is the flashing of lights in a location at the time of a smoke detection event. While light flashing may not normally be an attribute change associated with the smoke detection event, the user may wish for this additional safety procedure, and, thus, indicate that he or she wants the lights to flash when the smoke detector is set off (the indication being a request from the user entered through a user interface of the system). The exceptions may also be “recipes” that are represented as simple graphical entities on a graphical user interface that is used in conjunction with the system. Examples of graphical entities that could be used to define exceptions can be found in the aforementioned U.S. Pat. No. 9,465,718. In the case of the flashing lights during smoke detection event example, a user interface for the system may have graphical entity representing the flash lights on smoke alarm exception. To enter the exception, the user may move the graphical entity to the part of the home (which may be represented by another graphical entity) for which the rule should be integrated in addition to the default behavior. This action enters the exception into the control system by associating the lights and the smoke detection event in the virtual event matrix. The user could also enter other flashing light exceptions by associating a flashing light graphical entity with other devices, locations, and/or events indicated on the graphical user interface.

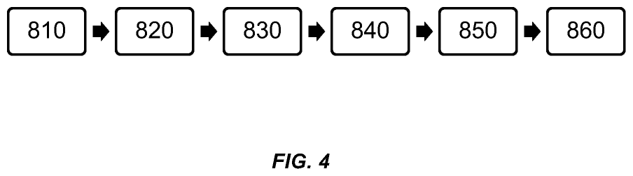

FIG. 4 is a conceptual drawing showing an execution chain according to embodiments of the invention. The figure illustrates processes by which an event expression is generated and the attributes of devices are changed as a result of the event. The details of specific features of the process of the execution chain will now be described.

The execution chain begins at step 810 in which a user enters a request at a user interface. Alternatively, the execution chain may begin as a result of information being provided to the control system from a device of the system. The user interface and device are operatively connected to the control system such that a request emanating from the user interface and/or information from the device is received by the receiving module of the control system, as described above.

After the control system receives the request or information, at step 820 an expression for an event is generated. As discussed above, the expression generation module will interpret the request or information to generate the event expression, and the event expression will specify the event with a formal description of a set of devices to receive the event. And the expression will have near natural language syntax.

At step 830 the event expression is interpreted to determine the device digital twins to be affected by the event. To make this determination, the expression interpretation module uses data from the group table, the location tree, and/or the virtual event matrix, as described above, and also combines sets of devices using algebra of sets (binary operators on sets). The expression interpretation module will also take into account any exceptions from the default behavior defined in the virtual event matrix.

At step 840 the virtual attributes of the digital twins are adjusted in accordance with the event. Data from the virtual event matrix may be used to determine how the attributes are to be changed based on the default behavior specified in the virtual event matrix.

At step 850 the device controllers create device control commands to change attributes of the devices of the system in accordance with the changes to the virtual attributes of the digital twins corresponding to the devices. And at step 860, the device commands are sent by the transmission module of the control system to the devices. Finally, at step 860 the devices receive the control commands, and thereby change their attributes in accordance with the event.

The following are examples illustrating systems and processes according to embodiments of the invention. The examples are given in terms of specific events being generated in control systems, and in terms of the corresponding changes made to attributes of devices operatively connected to the control systems.

In a first example, a control system is provided with features as described above, with the control system being operatively connected to a voice activated assistant and devices controlled by the system. The specific devices used in this case are an overhead light and a window shade operating device. For this example, a user in a master bedroom of an apartment decides that the room is too dark and needs more light. The user might then say “it's too dark in here,” “I want more light,” or some other statement indicating that the amount of light in the room needs to be increased. The statement is detected by the voice-activated assistant, which transmits the statement to the receiving module of the control system. Upon receiving the statement, the control system processes the request as follows.

For this event the control system must determine the location of the user. The location of the user can be determined by using one or more sensors that are operatively connected to the control system. As an alternative, the location of the user might be determined based on the known location of the voice activated assistance device that detected the user's statement.

The expression generation module translates the statement received from the voice-activation assistant into an event expression using well-defined syntax. The syntax of the event expression is in near natural language that corresponds to the request. In this example, the syntax for the event expression is brighter:@masterbedroom. The expression generation module can use voice recognition artificial intelligence to analyze the user's actual words to generate the event expression. Thus, the human facing input side of the system is separated from the control system's generation and interpretation of the event. This is advantageous as it allows the user to express his or her desire for more light in numerous ways and not in a limited or specific manner.

After generating the event expression of the lighting event in this example, the expression interpretation module of the control system selects target devices having attributes to be changed as a result of the event. As discussed above, the expression interpretation module may use a group table, a location tree, and a virtual event matrix to select the target devices. In this example, the brighter:@masterbedroom expression will be interpreted as requiring changing the attributes relevant for brightness of any of the lighting devices in the master bedroom by raising the shades of windows, as well as turning on or increasing the brightness of lights in the bedroom. This interpretation is made using data in the group table, event tree, and virtual event matrix, which indicate that the window shade operating device and the overhead lighting device are lighting event devices located in the master bedroom.

Next, the event interpretation module of the control system creates the control commands for changing attributes of the target devices determined by the expression interpretation module. As discussed above, the event interpretation module can use digital twins of the devices to adjust virtual attributes of the devices. In this case, the digital twin corresponding to the overhead light receives the event and changes its virtual attribute for the device from off to on or to brighter, if it is determined, using the virtual event matrix, that the attributes should be changed at this time. The corresponding device controller for the overhead light then generates the actual device commands to change one or more attributes based on the virtual attribute being changed in the digital twin. Similarly, the digital twin corresponding to the shade operating device and the shade operating device controller function to generate the command to open the shades if it is determined, using data from the virtual event matrix, that the time of day is such that opening the shades will increase light in the room.

Having generated the control commands, the transmission module of the control system sends the commands to the devices. Thus, the light in the master bedroom receives the command to change its attribute to on or brighten, and the shades for the window in the master bedroom receive the command to change its attribute to open (if appropriate at that time). The result is that the light in the master bedroom is increased, thereby fulfilling the user's desire that was initiated with him or her saying something such as “it's too dark.”

In a second example, the attributes of devices are changed by a control system according to an embodiment of the invention in response to the doorbell of a house being activated. The event is therefore initiated as a result of a sensor type device (the physical doorbell button next to the door or sensor) rather than a user entering a request through a user interface. That is, pushing a button generates a request for the control system. The control system is operatively connected to a hairdryer, a vacuum cleaner, a television, lights inside and outside of the door next to the doorbell, lights in a room where a user is located, headphones being used by the user, and the doorbell itself.

An indication that the doorbell button is activated is received by the receiving module of the control system, thereby generating a request in the control system to process. The expression generation module of the control system generates an event expression indicating that a doorbell event has occurred that is potentially relevant for a set of all devices in the house independent of their exact location, and the expression interpretation module interprets the expression to determine the target devices whose attributes may be changed as a result of the doorbell event. In this case, the virtual event matrix indicates that the hairdryer, vacuum cleaner, and television belong to a group of noise creating devices that need to be shut off or muted so that the user can hear the doorbell. As previously discussed, such a group could be automatically created when each of the devices is added to the system, or the group could be explicitly defined by the user. The virtual event matrix further indicates that the light inside of the door and the light outside of the door might need to be adjusted to provide light around the door. In this regard, the virtual event matrix may further indicate that if it is daytime, the light outside the door is not to be turned on, but if it is nighttime, the light outside the door needs to be turned on.

The event interpretation module interprets the event by adjusting the virtual attributes of the digital twins of the devices, which in turn results in the device controllers generating the control commands for changing the attributes of the devices. Specifically, control commands are generated for making the hairdryer, vacuum cleaner, and television quieter (or turned off) and control commands are generated for turning on the lights on the inside and outside of the door. Additionally, as indicated by the virtual event matrix, the control system issues commands for making the doorbell device sound at a time after the devices are made quieter.

This example also includes the use of an exception that has previously been entered into the control system to partially modify the interpretation of the event by the event interpretation module. The exception results from the user having entered in the control system that the lights in the room where the user is present should blink when there is a doorbell event if the user has on headphones. The exception is specifically entered in the virtual event matrix as an association with the doorbell event, and the exception is processed by the control system along with the other processing of the doorbell event. That is, the virtual event matrix indicates to the event interpretation module that the blinking light exception should be processed because the user has on headphones in a specific room. Thus, device control commands are generated for blinking the lights in the room, which would not have been the case had the exception not been entered into the system.

While the foregoing has described systems and methods according to embodiments of the invention in the context of a smart home environment, the invention is not limited to smart homes. In other embodiments, the systems and methods may be used to orchestrate other types of devices in locations outside of homes in the same manner as described above, e.g., through the generation of events that are interpreted with a control system using digital twins for connected devices. Indeed, those skilled in the art will recognize numerous potential applications for the invention as described herein with IoT devices and systems.

One example of another application of embodiments of the invention is in a smart factory, with the systems and methods providing functionalities to control machines, lights, doors, cranes, transport robots, and other devices and subsystems at the factory. Events generated in a smart factory could be used to change attributes of machines in the factory. For example, an event for the system may be generated as the result of a sensor device detecting an irregularity in some part of the manufacturing process. The event could then be processed by the control system to shut down or reduce the speed of the machines in one part of the factory where the irregularity is occurring (i.e., a group in a location), and the event could also interpreted to initiate a sample inspection process to determine if products of the machines in the part of the factory are affected by the irregularity. Examples of still further applications for the systems and methods described herein include smart buildings and smart cities operating with IoT networks.

As can be appreciated in view of the above descriptions, the aspects of the invention described herein provide systems, methods, and computer program products for controlling devices have many advantageous over prior art systems. In the context of smart home devices, prior art control systems often function in a manner akin to that of a simple remote control, and users must go through laborious process to add and set up devices within a system. With embodiments of the invention described herein, interactions with the user are made much easier. The user can initiate changes to devices in the system in a natural way. Moreover, the default behavior of the system causes the devices to work together in a natural way without configuration work by the user or a configuration expert, with the system producing the responses desired by the user, and new devices may easily be added to the system.

While various example embodiments of the invention have been described above, it should be understood that they have been presented by way of example, and not limitation. It is apparent to persons skilled in the relevant arts that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the general public, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A control system that is connectable to a plurality of devices, the control system comprising:
one or more computer processors; and
one or more memories storing instructions to be executed by the one or more computer processors,
wherein the instructions stored in the one or more memories are executable by the one or more computer processors to cause the control system to function as:
a receiving module that is capable of receiving a request that entails changing attributes of devices,
an expression generation module that is capable of generating, based on the request, an event expression corresponding to the changes in attributes of devices,
an expression interpretation module that is capable of interpreting the event expression to select target devices having attributes to be changed, the event interpretation module being configured to use (i) a group table that indicates groups of devices sharing at least one characteristic, (ii) a location tree indicating a hierarchy of locations for the devices, and (iii) a virtual event matrix correlating attributes of the devices to events,
an event interpretation module that is capable of generating device control commands for changing the attributes of the selected target devices, and
a transmission module that is capable of transmitting the device control commands to the selected target devices.

2. A system according to claim 1, wherein the event interpretation module includes (i) digital twins for the selected target devices, each digital twin having virtual attributes that correspond to the attributes of one of the selected target devices, and (ii) device controllers associated with each of the digital twins, the devices controllers being capable of generating device control commands for changing attributes of the selected target devices.

3. A control system according to claim 1, wherein the event expression generated by the expression generation module specifies the event and a description of a set of devices with attributes to be changed in accordance with the event.

4. A control system according to claim 3, wherein the description of the set of devices in the event expression includes at least one of names of the devices, types of the devices, user defined groups of devices, a location of devices, and
wherein set operators may be used to combine multiple sets of devices.

5. A control system according to claim 4, wherein the event expression generated by the expression generation module has near natural language syntax.

6. A control system according to claim 1, wherein the characteristics of the groups of devices in the group table include at least one of names, types, aspects, and functions of the devices.

7. A system comprising:
at least one user interface;
a control system according to claim 1 operatively connected to the at least one user interface; and
the plurality of devices operatively connected to the control system.

8. The system according to claim 7, wherein the plurality of devices include one or more of a lighting device, an audio device, a video device, a heating device, a cooling device, a cooking appliance, a cleaning appliance, a safety appliance, a window shade operating device, an alarm clock, a doorbell, a door lock, an alarm system, a temperature-control device, a lawn sprinkler system, a temperature sensor, a light sensor, a motion detector, a power-usage meter, a device detecting whether objects such as windows and doors are open or closed, and an internet communication device or sensor.

9. The system according to claim 7, wherein at least one of the plurality of devices is a virtual device.

10. A control system connectable to a plurality of devices, the control system comprising:
one or more computer processors; and
one or more memories storing instructions to be executed by the one or more computer processors,
wherein the instructions stored in the one or more memories are executable by the one or more computer processors to cause the control system to function as:
a receiving module that is capable of receiving a request that entails changing attributes of devices,
an expression generation module that is capable of generating an event expression corresponding to the changes in attributes of devices based on the request, the event expression (i) having near natural language syntax and (ii) specify an event and a description of a set of devices with attributes to be changed in accordance with the event,
an expression interpretation module that is capable of interpreting the event expression to select target devices having attributes to be changed,
an event interpretation module that is capable of generating device control commands for changing the attributes of the selected target devices, and
a transmission module that is capable of transmitting the device control commands to the selected target devices.

11. A control system according to claim 10, wherein the description of the set of devices in the event expression includes at least one of names of the devices, types of the devices, user defined groups of devices, and a location of devices

12. A system comprising:
at least one user interface;
a control system according to claim 10 operatively connected to the at least one user interface; and
a plurality of devices operatively connected to the control system.

12. The system according to claim 12, wherein the plurality of devices include one or more of a lighting device, an audio device, a video device, a heating device, a cooling device, a cooking appliance, a cleaning appliance, a safety appliance, a window shade operating device, an alarm clock, a doorbell, a door lock, an alarm system, a temperature-control device, a lawn sprinkler system, a temperature sensor, a light sensor, a motion detector, a power-usage meter, a device detecting whether objects such as windows and doors are open or closed, and an internet communication device or sensor.

13. A method for controlling a plurality of devices, the method comprising:
receiving at a computer control system a request that necessitates changes in attributes of the devices;
generating an event expression corresponding to the changes in attributes of the devices based on the request;
interpreting the event expression to select target devices having attributes to be changed as a result of the event, the determination being made by using (i) a group table that indicates groups of devices sharing at least one characteristic, (ii) a location tree indicating a hierarchy of locations for the devices, and (iii) a virtual event matrix correlating attributes of the devices to events;
generating device control commands for changing the attributes of the selected target devices; and
transmitting the device control commands to the selected target devices using a wired or wireless protocol.

14. A method according to claim 13, wherein event expression has near natural language syntax, and
wherein the event expression specifies an event and a description of a set of devices with attributes to be changed in accordance with the event,

15. A method according to claim 14, wherein the description of the set of devices in the event expression includes at least one of names, types, user defined groups of devices, and the location of devices intended to receive the event.

16. A method according to claim 13, wherein the device control commands are generated using (i) digital twins of the selected target devices, the digital twins having virtual attributes corresponding to the attributes of the selected target devices, and (ii) device controller associated with the digital twins.

17. A method according to claim 13, further comprising a step of providing an exception that (i) modifies attributes changes corresponding to an event or (ii) modifies the selected target of devices for attributes corresponding to an event.

18. A method according to claim 17, wherein the exception is added to at least one of the virtual event matrix and all or parts of the hierarchy of locations in the location tree.

19. A method according to claim 13, wherein the request is sent using a wired or wireless protocol from a user interface or a device of the plurality of devices.

20. A method according to claim 13, wherein the characteristics in the group table include at least one of names, types, aspects, and functions of the devices.
